(19) United States
(12) Patent Application Publication
(10) Pub. No.: US 2022/0122059 A1
(43) Pub. Date: Apr. 21, 2022

(54) PREPAID CARD VALUE REDEMPTION

(71) Applicant: EZGiftCard Inc., Austin, TX (US)

(72) Inventor: Iric Brooke Bressler, JR., Austin, TX (US)

(73) Assignee: EZGiftCard Inc.

(21) Appl. No.: 17/505,758

(22) Filed: Oct. 20, 2021

Related U.S. Application Data
(60) Provisional application No. 63/093,927, filed on Oct. 20, 2020.

(51) Int. Cl. G06Q 20/34; G06Q 20/28; G06Q 20/32; G06Q 30/06

(52) U.S. Cl. CPC G06Q 20/349; G06Q 20/342; G06Q 30/0601; G06Q 20/3276; G06Q 20/28

(57) ABSTRACT

A method of value redemption including identifying, via an application server communicatively coupled to a web server, navigation to a merchant cart webpage executed by the web server. Based at least in part on a determination that a prepaid card exists within a database communicatively coupled to the application server, the method may further include verifying information associated with the prepaid card, presenting an alert at a client device indicating the existence of the prepaid card, and applying a value of the prepaid card to a purchase made via the merchant cart webpage

### RELATED APPLICATIONS

This application claims priority to U.S. provisional patent application No. 63/093,927, filed Oct. 20, 2020, which is incorporated herein by reference.

### TECHNICAL FIELD

The present disclosure relates generally to e-commerce and purchases made via an online shopping cart. Specifically, the present disclosure relates to systems and methods for capturing and redeeming prepaid cards.

### BACKGROUND

Prepaid cards have been used ubiquitously throughout commerce as a sales tool used by merchants of various products and/or services to encourage consumers to make purchases. A prepaid card may include any stored-value card (SVC) that includes a payment card with a monetary value stored on the card itself and not in an external account maintained by a financial institution. Further, prepaid cards may also include prepaid debit cards and prepaid credit cards that include a payment card with a monetary value stored on the card itself and ties to or included within an external account maintained by a financial institution. Still further, prepaid cards may include gift cards. Gift cards may include a prepaid stored-value money card issued by a merchant or a financial institution that may be used as an alternative to cash for purchases. Prepaid cards may, for example, be given out by employers or organizations as rewards or gifts, may be given as gifts for birthdays and other special occasions, and may even be distributed by retailers and marketers as part of a promotion strategy to entice the recipients to purchase the merchants' products and/or services.

In some of the formats of prepaid cards identified above, data on the prepaid cards represent prepaid stored value that may only be used or redeemed to purchase products and/or services provided by a specific or particular merchant associated with the prepaid card. Further, prepaid cards may be stored by their owner in multiple multipurpose physical or digital locations. Inherently, this makes the prepaid card data, needed for the redemption of the corresponding prepaid card towards a purchase, difficult to find and access when trying to redeem the prepaid card on a shopping cart webpage owned and operated by that merchant. Redemption of the prepaid car in this example may include a step intensive process of first accessing the stored physical or digital location, finding the prepaid card data stored in that location, possibly copying the data either manually or digitally, and submitting the data manually or digitally into a number of input fields included within the merchant's cart webpage is time consuming and inefficient. Such a long or complicated merchant checkout process online has been statistically proven to decrease sales conversion by 21% and the current manual processes of redeeming prepaid cards online adds incremental inefficient steps.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of a prepaid card redemption system, according to an example of the principles described herein.

FIG. 2 is a component diagram of example components of a client device or a mobile device including prepaid card redemption services, according to an example of the principles described herein.

FIG. 3 is a component diagram of example components of an application server including prepaid card redemption services, according to an example of the principles described herein.

FIG. 4 illustrates a flow diagram of an example method of prepaid card identification, according to an example of the principles described herein.

FIG. 5 illustrates a flow diagram of an example method of prepaid card redemption, according to an example of the principles described herein.

FIG. 6 illustrates a computing system diagram illustrating a configuration for a data center that may be utilized to implement aspects of the technologies disclosed herein.

FIG. 7 illustrates a computer architecture diagram showing an example computer hardware architecture for implementing a computing device that may be utilized to implement aspects of the various technologies presented herein.

### DESCRIPTION OF EXAMPLE EMBODIMENTS

The present systems and methods described herein provides a simple, digital, and secure way, to allow for prepaid card data, regardless of original format, to be efficiently captured, stored, transported, and submitted into the input fields of a merchant cart webpage. The present systems and methods decrease the time and steps required to process and redeem a prepaid card towards a purchase online. This, in turn, improves throughput and reduces the computing recourse utilized in redeeming the prepaid card. Further, the present systems and methods provide the user with a more user-friendly online purchase experience and increases sales conversion rates for the merchant.

This disclosure provides systems and methods for digitally identifying information associated with the prepaid card, saving data defining that information, encrypting the data, transferring the data, and autonomously entering the data into corresponding prepaid card input fields on the merchant cart webpage. The systems may include a mobile device (e.g., smart phone) application, a browser extension, a backend data storage system (e.g., a cloud computing resource), and an application platform among other elements that allows for the transmission of the data defining the prepaid card information between each component within the system.

The mobile device application may be used as an input source by which the information or textual data included on the physical prepaid card is captured. In one example, the mobile device application may utilize an imaging device (e.g., a mobile device-integrated camera) included within the mobile device to capture an image of the prepaid card. Further, the mobile device application may execute an optical character recognition process to identify and ingest textual information and other information from physical prepaid card or a digital prepaid card and save that data defining the prepaid card information in a data storage device of the mobile device. The mobile device may establish a network connection such as an Internet connection, and the mobile device application may authenticate the mobile device, a user of the mobile device, and/or the application with a cloud computing resource. In one example, the data defining the prepaid card information may be encrypted for security purposes. The data defining the prepaid card information may be sent via hypertext transfer protocol (HTTP) request to a representational state transfer (REST) application program interface (API), which then saves the information to a relational database.

The systems and methods may also include the browser extension as mentioned above. The browser extension may be used as an output source of the prepaid card data. The user authenticates via a user interface (UI) (e.g., a graphical UI (GUI)) with their account information, and the extension then authenticates via HTTP request via REST API with the cloud computing resource to access their saved prepaid card information obtained as described above.

When the user navigates to any e-commerce merchant cart webpage, the browser extension uses uniform resource locator (URL) pattern matching to detect whether the vendor matches any prepaid cards the user has associated with their account. In instances where there exists a match within the cloud computing resource, the browser extension may alert the user. When prompted by the user, the browser extension may retrieve the prepaid card data through an HTTP request transmitted to the application servers and/or cloud computing resource and populates the appropriate fields on the cart webpage via JavaScript actions to apply the data associated with the prepaid card data.

In one example, the browser extension may also execute a command that allows the prepaid card data to be submitted into the e-commerce merchant cart webpage which may be a third-party webpage. This may produce an updated checkout page that reflects the data associated with the prepaid card collected and submitted to the cloud computing resource during the capture process described above.

The browser extension may also be an input source for prepaid card data. The browser extension may run an optical character recognition process while accessing an imaging device associated with a client device such as a computing device. In one example, a screen capture feature may also be used. In these examples, the systems and methods may also recognize and collect the data associated with the prepaid card from physical or digital prepaid cards and save that data to local memory in the computing device via the browser extension. The browser extension may transmit the data defining the prepaid card data via HTTP request to a REST API and the data may be stored to the relational database.

Additional aspects, alternatives and variations as would be apparent to persons of skill in the art are also disclosed herein and are specifically contemplated as included as part of the invention. The invention is set forth only in claims as allowed by the patent office in this or related applications, and the following summary descriptions of certain of certain examples are not in any way to limit, define or otherwise establish the scope of legal protection.

### Overview

Examples described herein provide a method of value redemption including identifying, via an application server communicatively coupled to a web server, navigation to a merchant cart webpage executed by the web server. Based at least in part on a determination that a prepaid card exists within a database communicatively coupled to the application server, the method may further include verifying information associated with the prepaid card, presenting an alert at a client device indicating the existence of the prepaid card, and applying a value of the prepaid card to a purchase made via the merchant cart webpage.

The determination that the prepaid card exists within the database communicatively coupled to the application server includes accessing, via the application server, the database, and searching for the information associated with the prepaid card. Based at least in part on a determination that the information associated with the prepaid card exists in the database, the method may further include sending an acknowledgement message to the application server and executing a browser extension at the client device. Based at least in part on a determination that the information associated with the prepaid card does not exist in the database, the method may further include sending a negative acknowledgement message to the application server indicating that information associated with the prepaid card does not exist, and not executing the browser extension at the client device.

The information associated with the prepaid card includes at least one of a card number, an expiry date, a card security code, a pin, a cardholder name, an issuing party, a merchant associated with the merchant cart webpage, a value of prepaid card, a quick response (QR) code, a universal resource locator (URL) of the merchant cart webpage, a URL associated with the merchant, an identification of a payment network, or combinations thereof.

Presenting the alert at the client device indicating the existence of the prepaid card may include executing a browser extension on the merchant cart webpage at the client device and presenting the alert via the browser extension. Applying the value of the prepaid card to the purchase made via the merchant cart webpage may include, via the browser extension, identifying selection of the prepaid card for redemption towards the purchase via the merchant cart webpage, identifying selection of a user-selectable button indicating application of the prepaid card, inputting the information associated with the prepaid card into respective fields within the merchant cart webpage, and completing the purchase made via the merchant cart webpage.

The method further includes identifying a user-selection defining instructions to add the prepaid card to the database, capturing the information associated with the prepaid card, encrypting the information associated with the prepaid card to create encrypted information associated with the prepaid card, and adding the encrypted information associated with the prepaid card to the database. The method may further include identifying execution of an application associated with the application server and authenticating the user with respect to the application.

Capturing the information associated with the prepaid card includes imaging, via an image capture device associated with a computing device executing the application, the prepaid card based at least in part on the user-selection defining instructions to add the prepaid card to the database, recognizing characters within an image of the prepaid card via optical character recognition, and confirming the information associated with the prepaid card is correct. Capturing the information associated with the prepaid card includes identifying manual entry of the information associated with the prepaid card.

Examples described herein also provide a non-transitory computer-readable medium storing instructions that, when executed, causes a processor to perform operations, including, identifying, via an application server communicatively coupled to a web server, navigation to a merchant cart webpage executed by the web server. Based at least in part on a determination that a prepaid card exists within a database communicatively coupled to the application server, the operations may include verifying information associated with the prepaid card, and presenting an alert at a client device indicating the existence of the prepaid card. The operations may include applying a value of the prepaid card to a purchase made via the merchant cart webpage.

The determination that the prepaid card exists within the database communicatively coupled to the application server includes accessing, via the application server, the database, and searching for the information associated with the prepaid card. Based at least in part on a determination that the information associated with the prepaid card exists in the database, the operations may include sending an acknowledgement message to the application server and executing a browser extension at the client device. Based at least in part on a determination that the information associated with the prepaid card does not exist in the database, the operations may include sending a negative acknowledgement message to the application server indicating that information associated with the prepaid card does not exist, and not executing the browser extension at the client device.

Presenting the alert at the client device indicating the existence of the prepaid card may include executing the browser extension on the merchant cart webpage at the client device and presenting the alert via the browser extension. Applying the value of the prepaid card to the purchase made via the merchant cart webpage may include, via the browser extension, identifying selection of the prepaid card for redemption towards the purchase via the merchant cart webpage, identifying selection of a user-selectable button indicating application of the prepaid card, inputting the information associated with the prepaid card into respective fields within the merchant cart webpage, and complete the purchase made via the merchant cart webpage.

The information associated with the prepaid card includes at least one of a card number, an expiry date, a card security code, a pin, a cardholder name, an issuing party, a merchant associated with the merchant cart webpage, a value of prepaid card, a quick response (QR) code, a universal resource locator (URL) of the merchant cart webpage, a URL associated with the merchant, an identification of a payment network, or combinations thereof.

The operations further include identifying a user-selection defining instructions to add the prepaid card to the database, capturing the information associated with the prepaid card, encrypting the information associated with the prepaid card to create encrypted information associated with the prepaid card, and adding the encrypted information associated with the prepaid card to the database.

The operations further include identifying execution of an application associated with the application server and authenticating the user with respect to the application. Capturing the information associated with the prepaid card includes imaging, via an image capture device associated with a computing device executing the application, the prepaid card based at least in part on the user-selection defining instructions to add the prepaid card to the database, recognizing characters within an image of the prepaid card via optical character recognition, and confirming the information associated with the prepaid card is correct. The operations may further include capturing the information associated with the prepaid card comprises identifying manual entry of the information associated with the prepaid card.

Examples described herein also provide a client device may include an imaging device, a processor, and a non-transitory computer-readable media storing instructions that, when executed by the processor, causes the processor to perform operations include identifying a user-selection defining instructions to add a prepaid card to a database, capturing information associated with the prepaid card, encrypting the information associated with the prepaid card to create encrypted information associated with the prepaid card, and adding the encrypted information associated with the prepaid card to the database.

The operations further include identifying execution of an application associated with an application server and authenticating a user with respect to the application. Capturing the information associated with the prepaid card may include imaging, via an image capture device associated with a computing device executing the application, the prepaid card based at least in part on the user-selection defining instructions to add the prepaid card to the database, recognizing characters within an image of the prepaid card via optical character recognition, and confirming the information associated with the prepaid card is correct. Capturing the information associated with the prepaid card may include identifying manual entry of the information associated with the prepaid card.

The operations further include identifying, via an application server communicatively coupled to a web server, navigation to a merchant cart webpage executed by the web server. Based at least in part on a determination that a prepaid card exists within the database communicatively coupled to the application server, the operations may further include verifying information associated with the prepaid card, and presenting an alert at a client device indicating the existence of the prepaid card. The operations may further include applying a value of the prepaid card to a purchase made via the merchant cart webpage.

Additionally, the techniques described in this disclosure may be performed as a method and/or by a system having non-transitory computer-readable media storing computer-executable instructions that, when executed by one or more processors, performs the techniques described above.

### EXAMPLE EMBODIMENTS

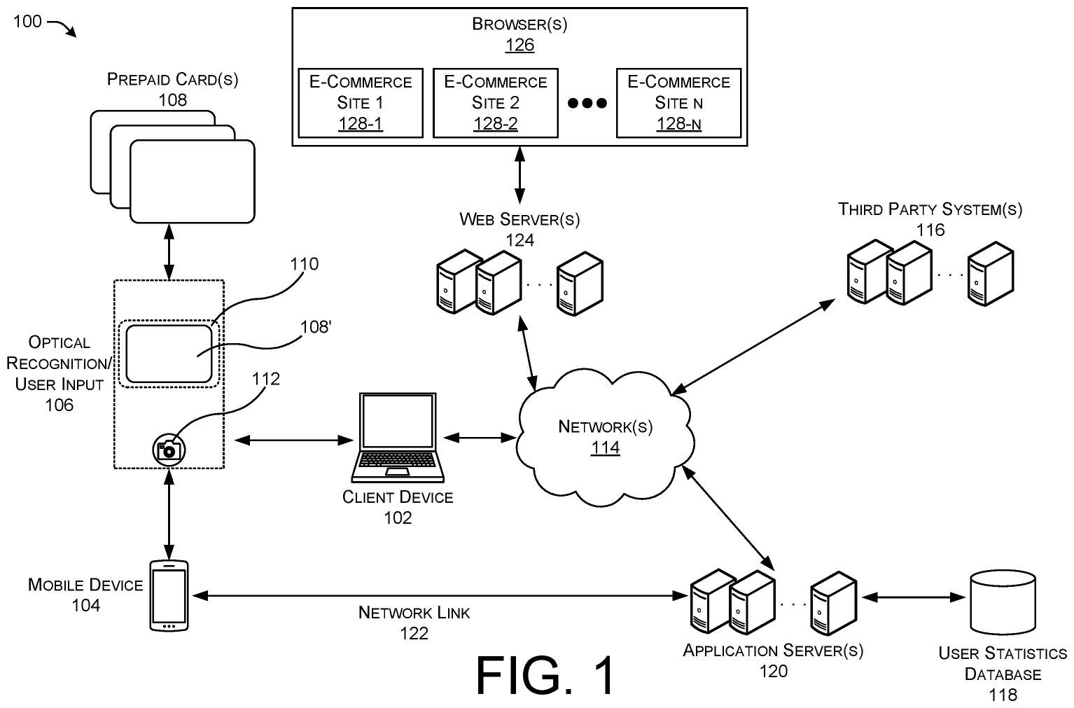

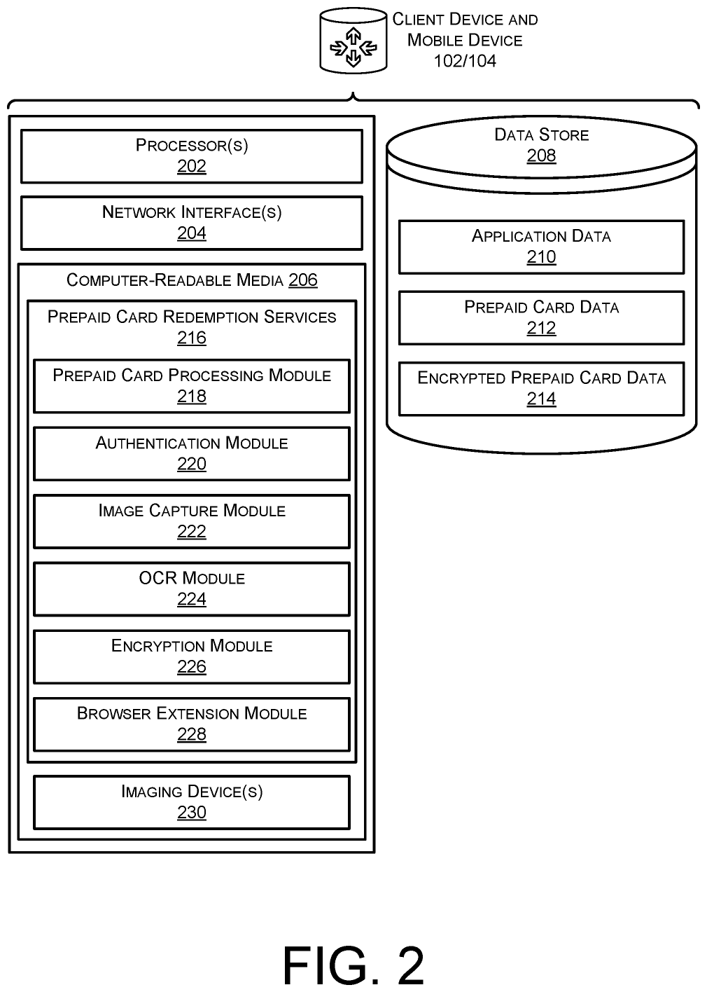

Turning now to the figures, FIG. 1 illustrates a system-architecture diagram of a prepaid card redemption system 100, according to an example of the principles described herein. The prepaid card redemption system 100 provides for the consumption, storage, encryption, retrieval, and automatic input of data defining information associated with the prepaid card into a merchant cart webpage. The prepaid card redemption system 100 may include a client device 102 directly or indirectly communicatively coupled to a network 114. Further, a mobile device 104 may also be directly or indirectly communicatively coupled to the network 114. In one example, the client device 102 and the mobile device 104 may be the same device, separate devices, or devices that are directly or indirectly communicatively coupled to one another or operated by the same user. In one example, the client device 102 and the mobile device 104 may include computing devices such as a personal computer, a workstation, a desktop computer, a laptop computer, a mobile computing devices, a tablet computing device, a network appliance, an e-reader, a smartphone, wearable computing devices (e.g., smart watches, optical head-mounted displays (OHMDs), etc.), relays, repeaters, routers, switches, encoder/receiver/transmitters (ERTs), appliances, servers, access points, gateway computing devices, or other computing devices. In one example, the client device may be any type of personal computing device such as a workstation, a desktop computer, a laptop computer, etc. Further, in one example, the mobile device 104 may be any type of mobile computing device such as a smartphone, a tablet, an e-reader, a wearable computing device, etc. With the mobile device 104 being any type of mobile computing device, a user may be allowed to utilize the mobile computing device as they physically visit a merchant and seek to redeem a prepaid card. Further, both the client device 102 and the mobile device 104 may be used to redeem the prepaid card via a merchant cart webpage accessible via the network 114. In one example, both the client device 102 and mobile device 104 may be used to capture information associated with the prepaid card via the use of an imaging device included within the client device 102 and/or the mobile device 104 such as a built in camera. More regarding the elements of the client device 102 and the mobile device 104 is described herein in connection with FIG. 2.

As described herein, the client device 102 and the mobile device 104 may be directly or indirectly communicatively coupled to a network 114. The network 114 may include any number of devices used to facilitate communication between the various computing devices depicted in FIG. 1 including, for example, relays, repeaters, routers, switches, ERTs, hubs, bridges, modems, appliances, servers, and access points, and gateway computing devices, among others. The network 114 may include any type of computing network including, for example, a wide area network (WAN), a metropolitan area network (MAN), a local area network (LAN), a neighborhood area network (NAN), a field area network (FAN), a personal area network (PAN), a cloud network, an intranet, an internet, the Internet, among other types of networks.

A number of web server(s) 124 may be communicatively coupled to the network 114. The web server(s) 124 may accept requests from, for example, the client device 102, the mobile device 104, third party system(s) 116, application server(s) 120 or other devices via HTTP and/or hypertext transfer protocol secure (HTTPS) or other network protocol utilized to distribute web pages. A user agent such as a web browser 126 or web crawler executed on the client device 102, the mobile device 104, third party system(s) 116, application server(s) 120 or other devices may initiate communication with the web server(s) 124 by making a request for a specific resource located on the web server(s) 124 using HTTP/HTTPS. For example, the browser(s) 126 may provide the other computing devices within the prepaid card redemption system 100 with access to a number of electronic commerce (e-commerce) site(s) 128-1, 128-2 . . . 128-N, where N is any integer greater than or equal to 1 (collectively referred to as “e-commerce site(s) 128”).

The e-commerce sites 128 may be any form of electronic commerce that allows consumers to directly buy products and/or services from merchants over the network(s) 114 (e.g., the Internet) using the browser(s) 126 or a mobile application executed on, for example, the mobile device 104. In relation to the e-commerce sites 128, a consumer may find a product of interest by visiting a web site of a merchant that is associated with the e-commerce sites 128. A consumer may access the merchant web site and the e-commerce sites 128 directly or by searching among alternative vendors using a shopping search engine, which displays the product availability and pricing at different e-commerce sites. As mentioned above, the consumer may shop online via the browser(s) 126, the e-commerce sites 128, and the website of a merchant that is associated with the e-commerce sites 128 using a range of different computing devices, including, for example, the client device 102, the mobile device 104, desktop computers, laptops, tablet computers, smartphones, and other computing devices that can communicate via the network (s) 114.

The prepaid card redemption system 100 may also include third party system(s) 116. The third party system(s) 116 may be coupled to the prepaid card redemption system 100 via the network(s) 114. The third party system(s) 116 may, in one example, embody any systems associated with the prepaid cards 108 such as those owned and/or operated by a financial institution, a banking institutions, a credit institution, a merchant, or other entity or issuer that provisions and/or manages funds associated with the prepaid card(s) 108. For example, financial institutions such as, for example, Berkshire Hathaway (e.g., American Express Company), Discover Financial, Mastercard Inc., Visa Inc., among other financial institutions, any individual, any banking institution, or any merchant or entity may be associated with the third party system(s) 116. In one example, client device 102, mobile device 104, web server(s) 124, and/or application server(s) 120 may access or request data from the third party system(s) 116 to confirm existence of the prepaid card(s) 108, the value of the prepaid card(s) 108, and data defining information associated with the prepaid card(s) 108. In one example, the third party system(s) 116 may serve as a backend data storage system that allows for the transfer of prepaid card data between each component within the prepaid card redemption system 100.

Further, in one example, the third party system(s) 116 may provide computing resources to, for example, the client device 102, the mobile device 104, the network 114, the web servers 124, the application server(s) 120, other devices described in connection with the prepaid card redemption system 100, and combinations thereof. In this example, the computing resources provided by the third party system(s) 116 may include, for example, processing resources, data storage resources, communication resources, network security resources, other types of computing resources, and combinations thereof. Still further, in one example, the third party system(s) 116 may provide the e-commerce sites 128 and/or the website of a merchant that is associated with the e-commerce sites 128 to the web server(s) 124 or other devices within the prepaid card redemption system 100.

The application server(s) 120 may include any number of servers that host applications for use by the client device 102, the mobile device 104, the network 114, the web servers 124, the third party system(s) 116, other devices described in connection with the prepaid card redemption system 100. In one example, the application server(s) 120 may provide facilities to create web applications such as the applications supporting the e-commerce sites 128. Further, in one example, the application server(s) 120 may provide a mobile application utilized by the mobile device 104 and/or the client device 102 to capture data associated with the prepaid cards 108 as described in more detail herein. Still further, the application server(s) 120 may provide a browser extension for use by the client device 102 and/or the mobile device 104 to redeem, via the e-commerce site(s) 128, the value of the prepaid card(1) 108 during a purchase of products and/or services. Even still further, the application server(s) 120 may serve as a backend data storage system that allows for the transfer of prepaid card data between each component within the prepaid card redemption system 100 in addition to or in place of the third party system(s) 116 as described above.

Turning now to the systems and methods by which the information associated with the prepaid card(s) 108 may be captured, processed, encrypted, and/or stored, the prepaid card(s) 108 may be obtained by a user. The mobile device 104 and/or the client device 102 may be used to capture an image of the prepaid card(s) 108 and apply an optical character recognition (OCR) process to the image and/or capture user-input as indicated at 106.

In one example, as depicted in FIG. 1, a styled overlay may be presented on the UI of the mobile application to the user on the mobile device 104 and/or the client device 102. In one example, once an “add” selection button is selected by a user, a styled overlay as indicated in FIG. 1 may be presented to the user in a UI of the mobile application. The styled overlay may include a target window 110 in which the user may align an image 108′ of the prepaid card(s) 108 in order for the imaging device(s) 230 to capture the image 108′ of the prepaid card(s) 108. In one example, once the image 108′ of the prepaid card(s) 108 is detected within the target window 110, the mobile application may instruct the imaging device(s) (FIG. 2, 230) to capture the image 108′ of the prepaid card(s) 108 autonomously. In one example, the user may manually select a capture button 112 once the image 108′ of the prepaid card(s) 108 is within the target window 110. In this manner, the image 108′ of the prepaid card(s) 108 may be captured.

Both the OCR processing and the user-input define information associated with the prepaid card(s) 108 including, for example, at least one of a card number, a primary account number, an expiry date, a card security code, a pin, a cardholder name, an issuing party, a merchant associated with the merchant cart webpage, a value of prepaid card, a quick response (QR) code, a universal resource locator (URL) of the merchant cart webpage (e.g., an e-commerce site 128), a URL associated with the merchant (e.g., web site of a merchant that is associated with the e-commerce sites 128), an identification of a payment network, and combinations thereof.

The mobile device 104 and/or the client device 102 may be equipped with an imaging device such as an integrated digital camera. In instances where an OCR process is utilized by the mobile device 104 and/or the client device 102 to obtain information associated with the prepaid card(s) 108, the imaging device (e.g., FIG. 2, 230), may be used to capture an image of the prepaid card(s) 108. In one example, the user may be prompted by the mobile application executed on the mobile device 104 and/or the client device 102 to place the prepaid card(s) 108 within a field of view of the imaging device, and may be prompted to select an image capture button to cause an image of the prepaid card(s) 108 to be captured by the imaging device. In one example, the mobile application may prompt the user to capture images of a first side of a prepaid card 108 and a second side of the prepaid card since required information may be present on both sides of the card. With image(s) of the prepaid card(s) 108 being captured, the mobile application may process the captured image(s) of the prepaid card(s) 108 including executing an OCR process on the image. The OCR process may be capable of producing a high degree of recognition accuracy for a very large number of fonts including fonts used in printing or stamping information on the prepaid card(s) 108. Further, the OCR processing may include reproducing formatted output that closely approximates the original markings on the prepaid card(s) 108 including position of the information on the prepaid card(s) 108, images, columns, and other textual and non-textual components. Because many prepaid cards 108 include similar information located in similar positions on the physical copy of the prepaid cards 108, the information gathered may be readily identified. Further, since the information presented via the markings on the prepaid cards 108 may have predefined formats, the OCR processing of the mobile application may be readily identified. For example, because an account number located on the prepaid card(s) 108 have 12 numbers (e.g., “1234 5678 9123 4567”) identifying a primary account number of the prepaid card 108, the OCR process of the mobile application may identify the primary account number based on its format and number of numerals included therein. Similarly, formats for the card number, expiry date, card security code, pin, cardholder name, issuing party, merchant associated with the merchant cart webpage, value of prepaid card, quick response (QR) code, URL of the merchant cart webpage (e.g., an e-commerce site 128), URL associated with the merchant (e.g., website of a merchant that is associated with the e-commerce sites 128), identification of the payment network, and combinations thereof, may be similarly identified for their formats, location on the physical embodiment of the prepaid card 108, and other identification methods.

In one example, some of the information may not have been able to be correctly captured via the OCR process. In these instances, the user may be prompted to manually enter that additional information. For example, in some instances, the monetary value associated with the prepaid card(s) 108 may not have been captured via the OCR process since that information may not be located on the physical embodiment of the prepaid card(s) 108. In this example, the user may be prompted and/or may volunteer any additional information by manually entering the data into a number of fields within a user interface (UI) of the mobile application.

In one example, the mobile application may allow for manual addition of information. In this example, the mobile application may present an “add manually” selection button to allow the user to input information associated with the prepaid card(s) 108. In this example, once the “add manually” selection button is selected by the user, the mobile application may identify the input from the user. In one example, a number of identified fields may be presented including fields for entering the card number, the primary account number, the expiry date, the card security code, the pin, the cardholder name, the issuing party, the merchant associated with the merchant cart webpage, the value of prepaid card, the URL of the merchant cart webpage (e.g., an e-commerce site 128), the URL associated with the merchant (e.g., website of a merchant that is associated with the e-commerce sites 128), the identification of the payment network, and combinations thereof. In this manner information associated with the prepaid card(s) 108 may be obtained by the mobile application.

As described above, the OCR processing and/or the user-input methods may be used by the mobile application to define the information associated with the prepaid card(s) 108. The mobile application may present to the user an “add to wallet” selection button to allow the information associated with the prepaid card(s) 108 to be added to a digital wallet. The digital wallet may be stored in any data storage device including, for example, a data storage device of the mobile device 104, the client device 102, the application server(s) 120, the web server(s) 124, the third party system(s) 116, and combinations thereof. In one example, the information associated with the prepaid card(s) 108 may be encrypted for security purposes. For example, the primary account number and the pin may be encrypted to ensure that the information is not obtainable by a third party. Thus, data defining the information associated with the prepaid card(s) 108 may be stored for further processing for redemption purposes.

The data defining the information associated with the prepaid card(s) 108 may be uploaded to the data storage device as described above. In one example, the data storage device may include or be facilitated by a cloud computing resource. The cloud computing resource may be embodied in and/or facilitated by, for example, the mobile device 104, the client device 102, the application server(s) 120, the web server(s) 124, the third party system(s) 116, and combinations thereof. Having captured, encrypted, and stored the information associated with the prepaid card(s) 108, the information may be used during a redemption of the value of the prepaid card(s) 108 during an online purchase of a product and/or service provided by a merchant.

In one example, the data defining the information associated with the prepaid card(s) 108 may be sent via HTTP request to a REST API, which then saves the information to a relational database. The relational database may include any database that organizes data based on a relational model that organizes the data into one or more tables (e.g., relations) of columns and rows and may include a unique key identifying each row. The rows may be referred to as records or tuples, and the columns are also called attributes. The table/relation represents one entity type such as a consumer, a product, a merchant, or other item related to the present systems and methods. The rows may represent instances of that type of entity such as “Smith,” “food,” or “Olive Garden Italian Restaurant,” and the columns representing values attributed to that instance such as an address of the merchant or a price of the product and/or service.

In one example, the prepaid card redemption system 100 may further include a user statistics database 118. The user statistics database 118 may store any data defining the user or consumer seeking to redeem the prepaid card(s) 108, the data defining the information associated with the prepaid card(s) 108, the use of the prepaid card(s) 108, and other data defining statistics associated with the prepaid card(s) 108. In one example, the user statistics database 118 may include the cloud computing resource and/or the relational database as described herein. Thus, in addition to or in place of the mobile device 104, the client device 102, the application server(s) 120, the web server(s) 124, and the third party system(s) 116, the user statistics database 118 may store the data defining the information associated with the prepaid card(s) 108 and other data associated with the capture and/or redemption of the prepaid card(s) 108.

Redemption of the prepaid card(s) 108 may be obtained via the data defining the information associated with the prepaid card(s) 108 as collected by the mobile device 104 and/or the client device 102. The client device 102 and/or the mobile device 104 may be used to redeem the prepaid card(s) 108 via the e-commerce sites 128. The client device 102 and/or the mobile device 104 may execute a browser and navigate to an e-commerce site 128 of a merchant to make a purchase of products and/or services available for purchase via the e-commerce site 128. A browser extension (e.g., FIG. 2, browser extension module 228) installed on the client device 102 and/or the mobile device 104 may be executed to begin a redemption process. In one example, the browser extension may determine whether redeemable prepaid card(s) 108 that may be used to purchase the products and/or services via the e-commerce site 128 have been stored in the database including the cloud computing resources, the relational database, or other data storage devices or sources described herein. In instances where a redeemable prepaid card(s) 108 is not identified or existent, the client device 102 and/or the mobile device 104 simply not present the browser extension and/or may terminate the execution of the browser extension.

In instances where one or more redeemable prepaid card(s) 108 are identified and are available for redemption at the e-commerce sites 128, the information associated with the prepaid card(s) 108 may be verified by accessing the data storage device such as the cloud computing resources, the relational database, or other data storage devices or sources described herein. The browser extension may present an alert or notification to the consumer indicating the existence of one or more redeemable prepaid card(s) 108 for use in purchasing the products and/or services, and the consumer may select one or more of the redeemable prepaid card(s) 108 to redeem the value of the prepaid card(s) 108. The browser extension may identify the selection of the prepaid card(s) 108 to redeem towards a purchase made via the e-commerce sites 128, and may, specifically, identify the selection of an “apply prepaid card(s)” selection button by the consumer.

At this point, the browser extension may input information associated with the prepaid card(s) 108 into a number of respective fields within the e-commerce site 128. In one example, the user may also be allowed to enter information into the fields within the e-commerce site 128. The e-commerce site 128 including the merchant cart page that identifies the products being purchased, the purchase prices, taxes associated with the purchase, other charges, and the value of the redeemable prepaid card(s) 108 applied to these costs are displayed.

The e-commerce site 128 including the merchant cart page may be refreshed to ensure that the value of the redeemable prepaid card(s) is presented and appropriately applied. Further, in one example, the browser extension may present to the user the option to apply any additional, redeemable prepaid card(s) 108 to the purchase. If there are additional, redeemable prepaid card(s) 108 to the purchase, the browser extension may be executed to process those additional, redeemable prepaid card(s) 108 as described herein. Once the browser extension has been utilized to discover, verify, and apply redeemable prepaid card(s) 108, the consumer may complete their purchase.

Having described the various elements of the prepaid card redemption system 100, the elements of the client device 102 and the mobile device 104 will now be described in connection with FIG. 2. FIG. 2 is a component diagram of example components of a client device 102 or a mobile device 104 including prepaid card redemption services, according to an example of the principles described herein. As illustrated, the client device 102 and/or the mobile device 104 may include one or more hardware processor(s) 202 configured to execute one or more stored instructions. The processor(s) 202 may comprise one or more cores. Further, the client device 102 and/or the mobile device 104 may include one or more network interfaces 204 configured to provide communications between the client device 102 and/or the mobile device 104 and other devices, such as devices associated with the system architecture of the prepaid card redemption system 100 of FIG. 1 including the network 114, the third party system(s) 116, the user statistics database 118, the application server(s) 120, the web server(s) 124, and/or other systems or devices associated with the client device 102 and/or the mobile device 104 and/or remote from the client device 102 and/or the mobile device 104. The network interfaces 204 may include devices configured to couple to personal area networks (PANs), wired and wireless local area networks (LANs), wired and wireless wide area networks (WANs), and so forth. For example, the network interfaces 204 may include devices compatible with the client device 102, the mobile device 104, the network 114, the third party system(s) 116, the user statistics database 118, the application server(s) 120, the web server(s) 124 and/or other systems or devices associated with the client device 102 and/or the mobile device 104.

The client device 102 and/or the mobile device 104 may also include computer-readable media 206 that stores various executable components (e.g., software-based components, firmware-based components, etc.). In one example, the computer-readable media 206 may include, for example, working memory, random access memory (RAM), read only memory (ROM), and other forms of persistent, non-persistent, volatile, non-volatile, and other types of data storage. In addition to various components discussed herein, the computer-readable media 206 may further store components to implement functionality described herein. While not illustrated, the computer-readable media 206 may store one or more operating systems utilized to control the operation of the one or more devices that comprise the client device 102 and/or the mobile device 104. According to one example, the operating system comprises the LINUX operating system. According to another example, the operating system(s) comprise the WINDOWS SERVER operating system from MICROSOFT Corporation of Redmond, Wash. According to further examples, the operating system(s) may comprise the UNIX operating system or one of its variants. It may be appreciated that other operating systems may also be utilized.

Additionally, the client device 102 and/or the mobile device 104 may include a data store 208 which may comprise one, or multiple, repositories or other storage locations for persistently storing and managing collections of data such as databases, simple files, binary, and/or any other data. The data store 208 may include one or more storage locations that may be managed by one or more database management systems. The data store 208 may store, for example, application data 210 defining computer-executable code utilized by the processor 202 to execute the applications described herein including for example, the mobile device application, the browser extension, the backend data storage system, and other applications associated with the prepaid card redemption services described herein.

Further, the data store 208 may store prepaid card data 212. The prepaid card data 212 may include any data obtained by the client device 102 and/or the mobile device 104 regarding the information associated with the prepaid card(s) 108, redemption of the prepaid card(s) 108, and statistics associated with the prepaid card(s) 108. Further, the data store 208 may store encrypted prepaid card data 214. The encrypted prepaid card data 214 may include encrypted forms of the prepaid card data 212 encrypted for security purposes. In one example, once the prepaid card data 212 is encrypted to create the encrypted prepaid card data 214, the prepaid card data 212 may no longer be stored within the data store. In one example, the encrypted prepaid card data 214 may be transmitted to the network 114, the third party system(s) 116, the user statistics database 118, the application server(s) 120, the web server(s) 124, and/or other systems or devices associated with the client device 102 and/or the mobile device 104 and/or remote from the client device 102 and/or the mobile device 104.

The computer-readable media 206 may store portions, or components, of the prepaid card redemption services 214. For instance, the prepaid card redemption services 214 of the computer-readable media 206 may include a prepaid card processing module 218 to, when executed by the processor(s) 202, process any data defining information associated with the prepaid card(s) 108 including before, during, and/or after obtaining the data from the physical prepaid card(s) 108. In one example, the prepaid card processing module 218 may include the mobile application executed on the mobile device 104 and/or the client device 102 described herein.

The computer-readable media 206 may also include an authentication module 220. The authentication module 220 may, when executed by the processor(s) 202, authenticate a user such as the consumer as to the mobile application and/or the browser extension (e.g., the browser extension module 228) as executed on the mobile device 104 and/or the client device 102. The authentication module 220 may cause authentication credentials such as usernames, passwords, etc. to be captured, stored, and identified when entered by the user. Further, the authentication module 220 may execute to test the user as to the credentials for access to the mobile application and/or the browser extension.

The computer-readable media 206 may also include an image capture module 222. The image capture module 222 may, when executed by the processor(s) 202, cause the imaging device(s) 230 integrated within the mobile device 104 and/or the client device 102 to capture and image. In one example, the image capture module 222 may cause the imaging device(s) 230 to capture images of the prepaid cards 108 when presented in front of the mobile device 104 and/or the client device 102.

Further, the computer-readable media 206 may include an OCR module 224. The OCR module 224 may, when executed by the processor(s) 202, recognize characters within the images captured by the imaging device(s) 230 including the information associated with the prepaid card(s) 108. In addition to the OCR module 224, the prepaid card processing module 218 may be executed to allow a user to manually enter the information associated with the prepaid card(s) 108 into a UI also presented by the prepaid card processing module 218. In this manner, both autonomous and manual entry of the information may be provided to the user.

The prepaid card redemption services 214 of the computer-readable media 206 may also include an encryption module 226. The encryption module 226 may, when executed by the processor(s) 202, encrypt any data defining the information associated with the prepaid card(s) 108 as captured by the prepaid card processing module 218 and/or the OCR module 224. Encryption of the data ensures that the sensitive information defining the prepaid card(s) 108 remains secure as that data is transmitted between computing devices within the prepaid card redemption system 100 and/or stored within the various devices within the prepaid card redemption system 100.

The prepaid card redemption services 214 of the computer-readable media 206 may also include the browser extension module 228. The browser extension module 228 may, when executed by the processor(s) 202, verify information associated with the prepaid card(s) 108, present alerts regarding the existence of redeemable prepaid cards, and apply the prepaid card(s) 108 to the purchase made on an e-commerce site 128 via a merchant cart webpage as described herein.

The client device 102 and/or the mobile device 104 may include a number of imaging device(s) 230. The imaging device(s) 230 may include any type of device capable of producing a digital image of the prepaid card(s) 108 including, for example, a charge coupled device (CCD), an active-pixel CMOS sensor, or other type of imaging device or sensor. In one example, the imaging device(s) 230 may be integrated into the client device 102 and/or the mobile device 104 or may be stand-alone devices communicatively coupled to the client device 102 and/or the mobile device 104.

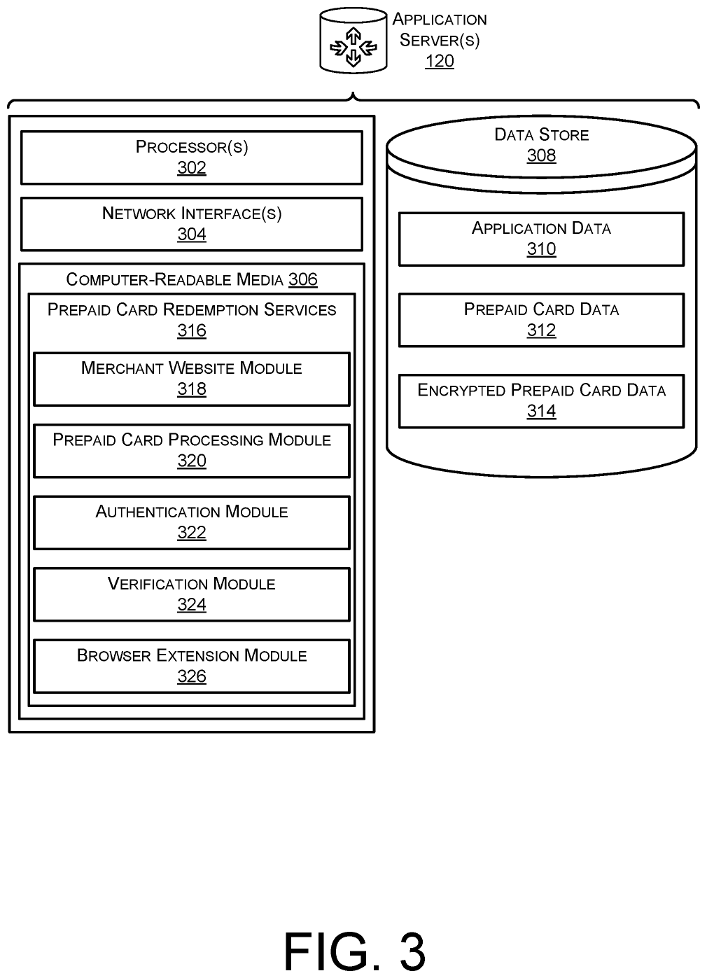

FIG. 3 is a component diagram of example components of the application server(s) 120 including prepaid card redemption services 314, according to an example of the principles described herein. As illustrated, the application server(s) 120 may include one or more hardware processor(s) 302 configured to execute one or more stored instructions. The processor(s) 302 may comprise one or more cores. Further, the application server(s) 120 may include one or more network interfaces 304 configured to provide communications between the application server(s) 120 and other devices, such as devices associated with the system architecture of the prepaid card redemption system 100 of FIG. 1 including the client device 102, the mobile device 104 the network 114, the third party system(s) 116, the user statistics database 118, the web server(s) 124, and/or other systems or devices associated with the application server(s) 120 and/or remote from the application server(s) 120. The network interfaces 304 may include devices configured to couple to personal area networks (PANs), wired and wireless local area networks (LANs), wired and wireless wide area networks (WANs), and so forth. For example, the network interfaces 304 may include devices compatible with the client device 102, the mobile device 104, the network 114, the third party system(s) 116, the user statistics database 118, the application server(s) 120, the web server(s) 124 and/or other systems or devices associated with the application server(s) 120.

The application server(s) 120 may also include computer-readable media 306 that stores various executable components (e.g., software-based components, firmware-based components, etc.). In one example, the computer-readable media 306 may include, for example, working memory, random access memory (RAM), read only memory (ROM), and other forms of persistent, non-persistent, volatile, non-volatile, and other types of data storage. In addition to various components discussed herein, the computer-readable media 306 may further store components to implement functionality described herein. While not illustrated, the computer-readable media 306 may store one or more operating systems utilized to control the operation of the one or more devices that comprise the application server(s) 120. According to one example, the operating system comprises the LINUX operating system. According to another example, the operating system(s) comprise the WINDOWS SERVER operating system from MICROSOFT Corporation of Redmond, Wash. According to further examples, the operating system(s) may comprise the UNIX operating system or one of its variants. It may be appreciated that other operating systems may also be utilized.

Additionally, the application server(s) 120 may include a data store 308 which may comprise one, or multiple, repositories or other storage locations for persistently storing and managing collections of data such as databases, simple files, binary, and/or any other data. The data store 308 may include one or more storage locations that may be managed by one or more database management systems. The data store 308 may store, for example, application data 310 defining computer-executable code utilized by the processor 302 to execute the applications described herein including for example, the mobile device application, the browser extension, the backend data storage system, and other applications associated with the prepaid card redemption services described herein.

Further, the data store 308 may store prepaid card data 312. The prepaid card data 312 may include any data obtained by the application server(s) 120 regarding the information associated with the prepaid card(s) 108, redemption of the prepaid card(s) 108, and statistics associated with the prepaid card(s) 108. In one example, the prepaid card data 312 may be encrypted by the encryption module 226 of the client device 102 and/or the mobile device 104 since the prepaid card data 312 will have been transmitted to the application server(s) 120 via the network 114. As described above, the encrypted prepaid card data 314 may include encrypted forms of the prepaid card data 312 encrypted for security purposes. In one example, once the prepaid card data 312 is encrypted to create the encrypted prepaid card data 314, the prepaid card data 312 may no longer be stored within the data store. In one example, the encrypted prepaid card data 314 may be transmitted to the network 114, the third party system(s) 116, the user statistics database 118, the web server(s) 124, and/or other systems or devices associated with the application server(s) 120 and/or remote from the application server(s) 120.

The computer-readable media 306 may store portions, or components, of the prepaid card redemption services 314. For instance, the prepaid card redemption services 314 of the computer-readable media 306 may include a merchant website module 318. The merchant website module 318, when executed by the processor(s) 302, causes a merchant website such as the e-commerce sites 128 to be displayed via the web server(s) 124. The e-commerce sites 128 may include an online shopping cart where products and/or services may be presented as selected by a consumer. In one example, the third party system(s) 116 and/or the web server(s) 124 may also participate in the presentation of the e-commerce sites 128 and may include their own respective merchant website module 318 or portions thereof.

The prepaid card redemption services 314 of the computer-readable media 306 may further include a prepaid card processing module 320 to, when executed by the processor(s) 302, process any data defining information associated with the prepaid card(s) 108 including before, during, and/or after obtaining the data from the client device 102 and/or the mobile device 104. In one example, the prepaid card processing module 320 may function along with the mobile application executed on the mobile device 104 and/or the client device 102 described herein.

The computer-readable media 306 may also include an authentication module 322. The authentication module 322 may, when executed by the processor(s) 302, authenticate a user such as the consumer as to the mobile application and/or the browser extension (e.g., the browser extension module 328) as executed on the mobile device 104 and/or the client device 102. The authentication module 322 may cause authentication credentials such as usernames, passwords, etc. to be captured, stored, and identified when entered by the user. Further, the authentication module 320 may be executed to test the user as to the credentials for access to the mobile application and/or the browser extension. In one example, the user may provide the credentials via the authentication module 322 in order to install and/or execute the browser extension module 326 a provided by the or the application server(s) 120 and/or the browser extension module 228 as executed by the client device 102 and/or the mobile device 104.

Further, the computer-readable media 306 may further include a verification module 324. The verification module 324 may, when executed by the processor(s) 302, verify the existence of data defining information associated with the prepaid card(s) 108 within a data storage device (e.g., the cloud computing resource and/or the relational database as described herein) Once verified, the data defining information associated with the prepaid card(s) 108 may be applied to the purchase of the products and/or services.

The prepaid card redemption services 314 of the computer-readable media 306 may also include the browser extension module 328. The browser extension module 328 may, when executed by the processor(s) 302, verify information associated with the prepaid card(s) 108, present alerts regarding the existence of redeemable prepaid cards, and apply the prepaid card(s) 108 to the purchase made on an e-commerce site 128 via a merchant cart webpage as described herein.

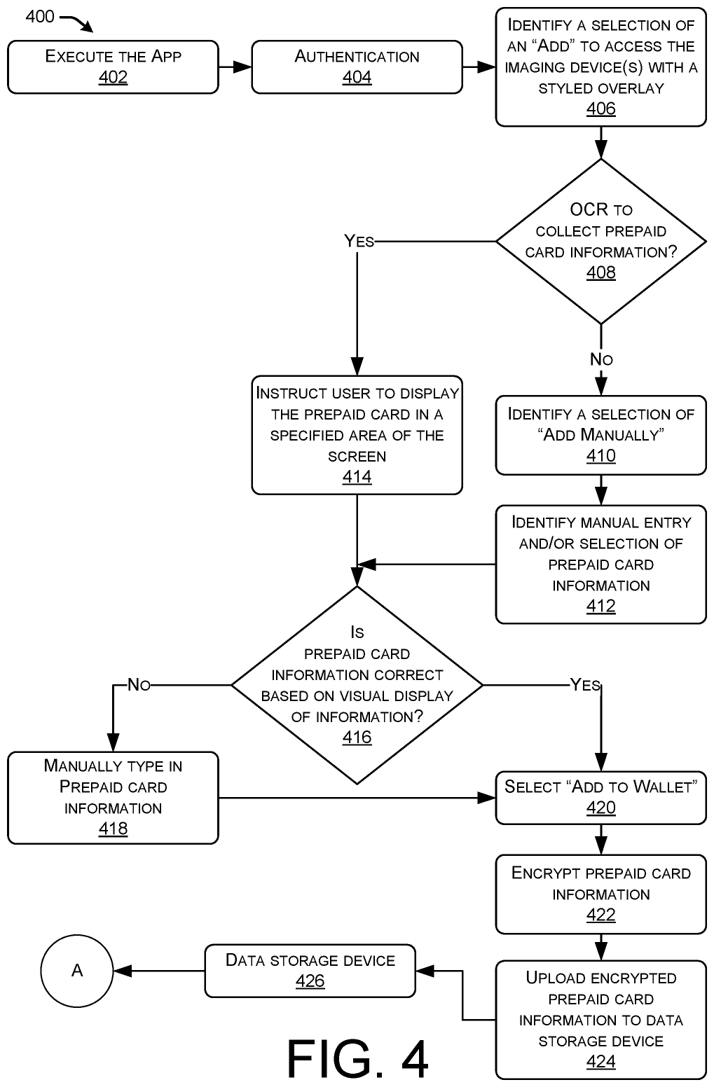

FIG. 4 illustrates a flow diagram of an example method 400 of prepaid card identification, according to an example of the principles described herein. The method of FIG. 4 may be executed via the processor(s) 202, 302 of the client device 102, mobile device 104, and/or the authentication server(s) 120 executing the various modules described herein. The method 400 may include executing the mobile application at the client device 102 and/or the mobile device 104 as indicated at 402. At 404, the mobile application may then be used to authenticate the user via execution of the authentication module 220 of the client device 102 and/or the mobile device 104 and/or via the authentication module 322 of the application server(s) 120. In one example, the authentication module 322 of the application server(s) 120 may be used by the client device 102 and/or mobile device 104 to authenticate access to the functionality of the prepaid card redemption system 100 as described herein. Authentication of the client device 102, mobile device 104, and/or the authentication server(s) 120 ensures that any data obtained relating to the prepaid card(s) 108 is collected and stored in a digitally secure manner without the risk of a third party obtaining the value of the prepaid card(s) 108.

At 406, the prepaid card processing module 218, 320 may be executed to identify selection of an “add” selection button by a user. At 406, once the “add” selection button is selected, the imaging device(s) 230 of the client device 102 and/or the mobile device 104 may be activated and accessed in order to capture image of the prepaid card(s) 108. In one example, once the “add” selection button is selected a styled overlay as indicated in FIG. 1 may be presented to the user in a UI of the mobile application. The styled overlay may include a target window 110 in which the user may align an image 108′ of the prepaid card(s) 108 in order for the imaging device(s) 230 to capture the image 108′ of the prepaid card(s) 108. In one example, once the image 108′ of the prepaid card(s) 108 is detected within the target window 110, the mobile application may instruct the imaging device(s) 230 to capture the image 108′ of the prepaid card(s) 108 autonomously. In one example, the user may manually select a capture button 112 once the image 108′ of the prepaid card(s) 108 is within the target window 110. In this manner, the image 108′ of the prepaid card(s) 108 may be captured. Thus, at 406, the image capture module 222 of the client device 102 and/or the mobile device 104 may be executed to capture the image 108′ of the prepaid card(s) 108.

The method 400 may include an OCR process and/or the ability to manually enter the information associated with the prepaid card(s) 108. At 408, a determination may be made as to whether to execute the OCR module 224 to collect the information associated with the prepaid card(s) 108 from the image 108′ of the prepaid card(s) 108. In response to a determination that the OCR module 224 is to be executed (408, determination YES), the user may be instructed via, for example, a prompt presented to the user via the UI of the mobile application to display the prepaid card(s) 108 within the target window 110 to capture the image 108′ of the prepaid card(s) 108. The mobile application may then perform the OCR process on the capture image.

In contrast, in response to a determination that the OCR module 224 is not to be executed (408, determination NO), the user, at 410, may select an “add manually” selection button to allow the user to input information associated with the prepaid card(s) 108 via, for example, a software or hardware keypad or other text entry device. The mobile application may identify the manual entry of the information associated with the prepaid card(s) 108 at 412.

Whether the OCR process or the manual entry process is selected, at 416 a determination may be made as to whether the information associated with the prepaid card(s) 108 is correct. In one example, a visual display of the prepaid card(s) 108 may be presented to the user so that the user may visually confirm correct entry. If, at 416, it is determined that the information associated with the prepaid card(s) 108 is not correct (416, determination NO), the user may manually enter the information associated with the prepaid card(s) 108 at 418. In contrast, if, at 416, it is determined that the information associated with the prepaid card(s) 108 is correct (416, determination YES), an “add to wallet” selection button may be presented to the user via the UI of the mobile application to allow the user to add the information associated with the prepaid card(s) 108 to a digital wallet and the user may select the “add to wallet” selection button at 420. The digital wallet may include any information required to apply the prepaid card(s) 108 to a purchase made via the e-commerce sites 128. The selection at 420 of the “add to wallet” selection button causes data defining the information associated with the prepaid card(s) 108 to be stored in a data storage device such as, for example, the cloud computing resource, the relational database, or other data storage device in any of the mobile device 104, the client device 102, the application server(s) 120, the web server(s) 124, the third party system(s) 116, and combinations thereof.

At 422, before transmitting the data defining the information associated with the prepaid card(s) 108 to another device within the prepaid card redemption system 100 other than the client device 102 and/or the mobile device 104, the data may be encrypted. Encrypting the data provides for the data to be safely transmitted and stored in other devices without a significant threat or possibility of a third party accessing that data.

At 424, the encrypted data defining the information associated with the prepaid card(s) 108 may be uploaded or otherwise transmitted to a data storage device. As mentioned above, the data storage device may include the cloud computing resource, the relational database, or other data storage device in any of the mobile device 104, the client device 102, the application server(s) 120, the web server(s) 124, the third party system(s) 116, and combinations thereof. In one example, the application server(s) 120 and/or the user statistics database 118 may store this data. Further, a local copy of the data (encrypted or non-encrypted) may be stored locally at the client device 102 and/or the mobile device 104.

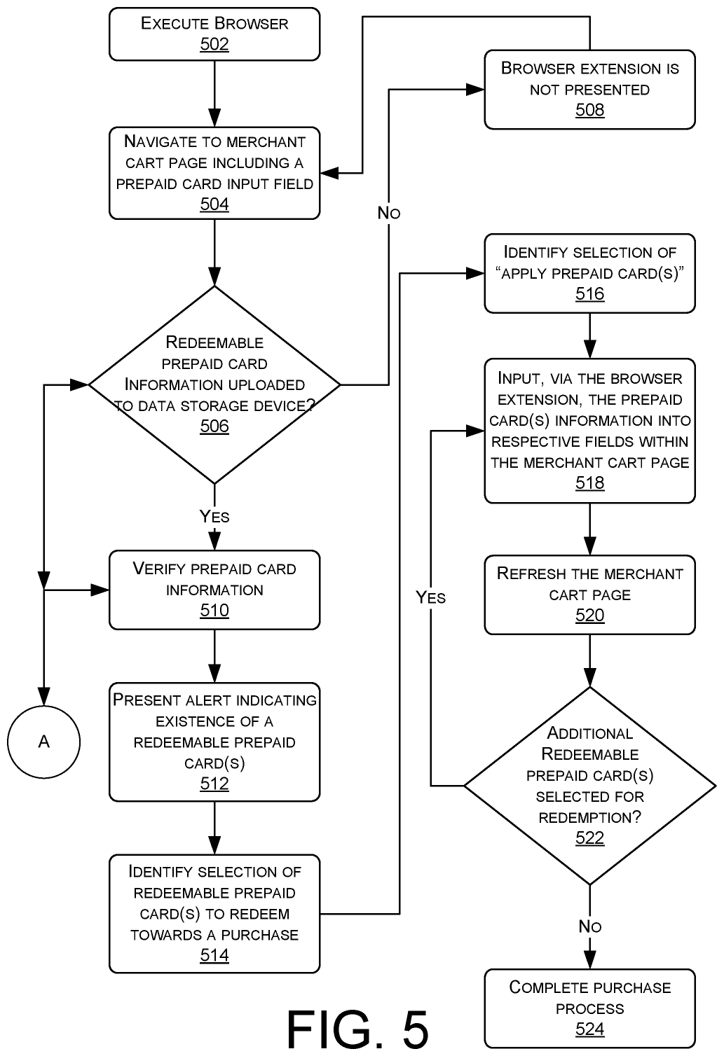

Having described the method by which the data defining the information associated with the prepaid card(s) 108 is obtained, encrypted, transmitted, and/or stored, FIG. 5 illustrates a flow diagram of an example method 500 of prepaid card redemption, according to an example of the principles described herein. Redemption of the value of the prepaid card(s) 108 may not occur for a user that is not implementing the present systems and methods since users may often forget the fact that they have a physical prepaid card 108 that may be used during their purchases or may not have access to their physical prepaid card(s) 108 when they wish to make such purchases. Thus, the present systems and methods provide a more user-friendly way to access, apply, and redeem the value of the prepaid card(s) 108.

At 502, the user may execute the browser(s) 126 on the client device 102 and/or the mobile device 104. At 504, the user may navigate to a merchant cart page such as the e-commerce sites 128 that includes a prepaid card input field. In one example, the browser extension module 228, 326 described herein may be executed by the processor(s) 202, 302 automatically. In this example, the triggering of the execution of the browser extension module 228, 326 may be based on execution of the browser(s) 126, detection of a URL of the e-commerce site 128 or a web site of a merchant that is associated with the e-commerce sites 128 or navigation to the e-commerce site 128 or a website of a merchant that is associated with the e-commerce sites 128, or other triggering events that indicate that the prepaid card(s) 108 may be utilized in a financial transaction. The browser extension module 228, 326 may be installed on the client device 102 and/or the mobile device 104 and may monitor the execution of the browser(s) 126 and/or the URLs accessed by the browser(s) 126.

In one example, the browser extension module 228, 326 described herein may be executed by the processor(s) 202, 302 when triggered based on the location of the client device 102 and/or mobile device 104 with relation to a brick and mortar store of a merchant at which the redeemable prepaid card(s) 108 may be redeemed. In this example, the client device 102 and/or mobile device 104 may track their respective physical locations using, for example, a location-based service (LBS) and/or a real-time locating system (RTLS). The LBS and/or RTLS may include any service provided to the client device 102 and/or mobile device 104 that utilizes geographic data and information to locate the geographic position of the client device 102 and/or mobile device 104 relative to a brick and mortar store of a merchant and provide services or information to users. The LBS and/or RTLS may utilize, for example, active or passive location detection utilizing radio signal delays of a number of closest cell-phone towers, global positioning system (GPS) services and processes, trilateration, and other geolocation processes.

Once the physical location of the client device 102 and/or mobile device 104 is detected via the mobile application and/or the browser extension, it may be determined if and when a user (presumably carrying the client device 102 and/or mobile device 104) enters or comes within a predefined distance of the brick and mortar store of a merchant. Entering or coming into the predefined distance of the brick and mortar store of the merchant triggers the browser extension module 228, 326 to execute and perform the processes as described herein in connection with the redemption of the prepaid cards including, for example, determining the existence of data defining information associated with the prepaid card(s) 108 within the data storage device 426, verifying the information associated with the prepaid card(s) 108, presenting alerts to the user of the existence of one or more redeemable prepaid card(s) that may be redeemed at the brick and mortar store of the merchant, and other processing including elements 506 through 524 as described below.

At 506, the browser extension module 228, 326 may determine whether data defining information associated with the prepaid card(s) 108 that may be redeemable at the e-commerce site 128 has been uploaded or stored in the data storage device 426. In one example, the browser extension module 228, 326 may access the data storage device 426 via callout “A” as indicated in FIGS. 4 and 5. In this manner, the browser extension module 228, 326 can confirm whether or not the prepaid card(s) 108 that may be redeemable at the e-commerce site 128 has been uploaded or stored in the data storage device 426. In one example, the browser extension module 228, 326 may also access the data store 208 of the client device 102 and/or the mobile device 104, and specifically, the prepaid card data 212 and/or the encrypted prepaid card data 214 since the browser extension module 228, 326 is executed on the client device 102 and/or the mobile device 104.

In response to a determination that no data defining information associated with the prepaid card(s) 108 that may be redeemable at the e-commerce site 128 has been uploaded or stored in the data storage device 426 (506, determination NO), then the browser extension module 228, 326 may not be presented to the user for use at the webpage at which the user has navigated. In one example, the method 500 may proceed from 508 back to 504 to again identify navigation to a merchant cart page such as the e-commerce sites 128 that includes a prepaid card input field.

In response to a determination that data defining information associated with the prepaid card(s) 108 that may be redeemable at the e-commerce site 128 has been uploaded or stored in the data storage device 426 (506, determination YES), then the browser extension module 228, 326 may communicate with the verification module 324 of the application server(s) 120 to, at 510, verify the data defining the information associated with the prepaid card(s) 108. Again, the browser extension module 228, 326 and the verification module 324 may access the data storage device 426 to make the verification at 510.

At 512, an alert may be presented to the user via the browser extension module 228, 326 and any associated UIs to indicate to the user the existence of the redeemable prepaid card(s) 108 that may be used at the e-commerce site 128 the user has navigated to. In one example, the browser extension module 228, 326 may include a selectable button that allows the user to select one or more of the prepaid card(s) 108 for use at the e-commerce site 128. The browser extension module 228, 326 may identify a user selection of one or more of the redeemable prepaid card(s) 108 for redemption towards a purchase made at the e-commerce site 128 at 514. Further, at 516, the browser extension module 228, 326 may identify a user selection of the “apply prepaid card(s)” selection button that indicates the desire of the user to apply those prepaid card(s) 108 selected at 514.

At 518, the browser extension module 228, 326 may input the data defining the information associated with the prepaid card(s) 108 into respective fields within the e-commerce site 128 such as, for example, fields within the shopping cart or checkout page of the merchant website. The e-commerce site 128 may be refreshed at 520 to allow the e-commerce site 128 to properly reflect the application of the redeemable prepaid card(s) 108 towards the purchase price of the goods or services the user has placed in the online shopping cart of the e-commerce site 128. Further, refreshing of the e-commerce site 128 at 520 allows for the purchase price of the products and/or services within the shopping cart to be updated with a new total cost that reflects the original price of the goods and/or services minus the value of the prepaid card(s) 108.

At 522, it may be determined whether additional redeemable prepaid card(s) 108 were selected for redemption at 514 and 516. In many instances, a plurality of prepaid card(s) 108 may be applied to a purchase within the e-commerce site 128. Thus, in response to a determination that additional redeemable prepaid card(s) 108 were selected for redemption (522, determination YES), then the method 500 may loop back to 518 and 520 in order to input data related to those additional prepaid card(s) 108 and refresh the e-commerce site 128 to reflect a new total cost of the products and/or services.

In response to a determination that additional redeemable prepaid card(s) 108 were not selected for redemption (522, determination NO), then the purchase process provided via the e-commerce site 128 may be completed with the redeemable prepaid card(s) 108 having been applied to the purchase price.

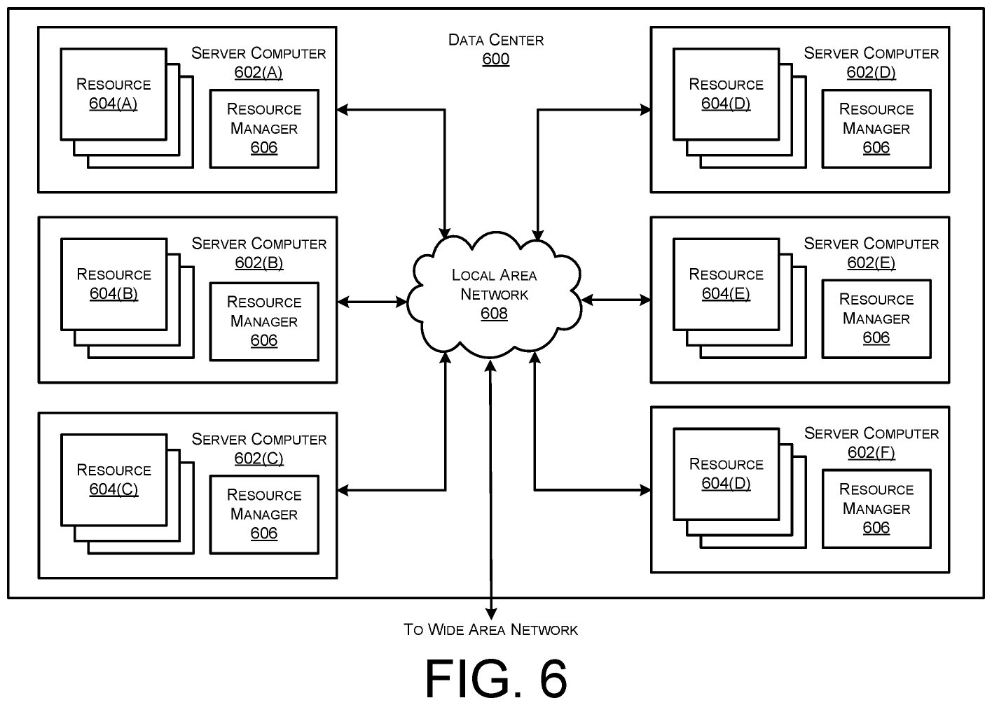

FIG. 6 illustrates a computing system diagram illustrating a configuration for a data center 600 that may be utilized to implement aspects of the technologies disclosed herein. The example data center 600 shown in FIG. 6 includes several server computers 602A-602F (which might be referred to herein singularly as “a server computer 602” or in the plural as “the server computers 602) for providing computing resources. In some examples, the resources and/or server computers 602 may include, or correspond to, any type of networked device described herein. Although described as servers, the server computers 602 may comprise any type of networked device, such as servers, switches, routers, hubs, bridges, gateways, modems, repeaters, access points, etc.

The server computers 602 may be standard tower, rack-mount, or blade server computers configured appropriately for providing computing resources. In some examples, the server computers 602 may provide computing resources 604 including data processing resources such as VM instances or hardware computing systems, database clusters, computing clusters, storage clusters, data storage resources, database resources, networking resources, virtual private networks (VPNs), and others. Some of the server computers 602 may also be configured to execute a resource manager 606 capable of instantiating and/or managing the computing resources. In the case of VM instances, for example, the resource manager 606 may be a hypervisor or another type of program configured to enable the execution of multiple VM instances on a single server computer 602. Server computers 602 in the data center 600 may also be configured to provide network services and other types of services.

In the example data center 600 shown in FIG. 6, an appropriate LAN 608 is also utilized to interconnect the server computers 602A-602F. It may be appreciated that the configuration and network topology described herein has been greatly simplified and that many more computing systems, software components, networks, and networking devices may be utilized to interconnect the various computing systems disclosed herein and to provide the functionality described above. Appropriate load balancing devices or other types of network infrastructure components may also be utilized for balancing a load between data centers 600, between each of the server computers 602A-602F in each data center 600, and, potentially, between computing resources in each of the server computers 602. It may be appreciated that the configuration of the data center 600 described with reference to FIG. 6 is merely illustrative and that other implementations may be utilized.

In some examples, the server computers 602 and or the computing resources 604 may each execute/host one or more tenant containers and/or virtual machines to perform techniques described herein.

In some instances, the data center 600 may provide computing resources, like tenant containers, VM instances, VPN instances, and storage, on a permanent or an as-needed basis. Among other types of functionality, the computing resources provided by a cloud computing network may be utilized to implement the various services and techniques described herein. The computing resources 604 provided by the cloud computing network may include various types of computing resources, such as data processing resources like tenant containers and VM instances, data storage resources, networking resources, data communication resources, network services, VPN instances, and the like.

Each type of computing resource 604 provided by the cloud computing network may be general-purpose or may be available in a number of specific configurations. For example, data processing resources may be available as physical computers or VM instances in a number of different configurations. The VM instances may be configured to execute applications, including web servers, application servers, media servers, database servers, some or all of the network services described above, and/or other types of programs. Data storage resources may include file storage devices, block storage devices, and the like. The cloud computing network may also be configured to provide other types of computing resources 604 not mentioned specifically herein.

The computing resources 604 provided by a cloud computing network may be enabled in one example by one or more data centers 600 (which might be referred to herein singularly as “a data center 600” or in the plural as “the data centers 600). The data centers 600 are facilities utilized to house and operate computer systems and associated components. The data centers 600 typically include redundant and backup power, communications, cooling, and security systems. The data centers 600 may also be located in geographically disparate locations. One illustrative example for a data center 600 that may be utilized to implement the technologies disclosed herein is described herein with regard to, for example, FIGS. 1 through 5.

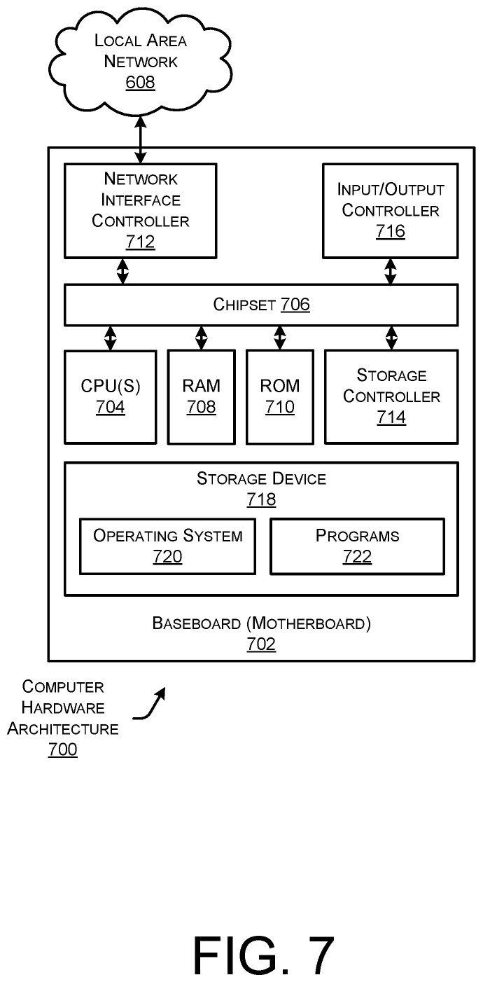

FIG. 7 illustrates a computer architecture diagram showing an example computer hardware architecture 700 for implementing a computing device that may be utilized to implement aspects of the various technologies presented herein. The computer hardware architecture 700 shown in FIG. 7 illustrates the client device 102, the mobile device 104, the network 114, the third party system(s) 116, the user statistics database 118, the application server(s) 120, the web server(s) 124, and/or other systems or devices associated with the prepaid card redemption system 100 and/or remote from the prepaid card redemption system 100, a workstation, a desktop computer, a laptop, a tablet, a network appliance, an e-reader, a smartphone, or other computing device, and may be utilized to execute any of the software components described herein. The computer 700 may, in some examples, correspond to a network device (e.g., client device 102, the mobile device 104, the network 114, the third party system(s) 116, the user statistics database 118, the application server(s) 120, and/or the web server(s) 124) described herein, and may comprise networked devices such as servers, switches, routers, hubs, bridges, gateways, modems, repeaters, access points, etc.

The computer 700 includes a baseboard 702, or “motherboard,” which is a printed circuit board to which a multitude of components or devices may be connected by way of a system bus or other electrical communication paths. In one illustrative configuration, one or more central processing units (CPUs) 704 operate in conjunction with a chipset 706. The CPUs 704 may be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 may provide an interface to a RAM 708, used as the main memory in the computer 700. The chipset 706 may further provide an interface to a computer-readable storage medium such as a read-only memory (ROM) 710 or non-volatile RAM (NVRAM) for storing basic routines that help to startup the computer 700 and to transfer information between the various components and devices. The ROM 710 or NVRAM may also store other software components necessary for the operation of the computer 700 in accordance with the configurations described herein.

The computer 700 may operate in a networked environment using logical connections to remote computing devices and computer systems through a network, such as the client device 102, the mobile device 104, the network 114, the third party system(s) 116, the user statistics database 118, the application server(s) 120, the web server(s) 124, among other devices. The chipset 706 may include functionality for providing network connectivity through a Network Interface Controller (NIC) 712, such as a gigabit Ethernet adapter. The NIC 712 is capable of connecting the computer 700 to other computing devices within the prepaid card redemption system 100 and external to the prepaid card redemption system 100. It may be appreciated that multiple NICs 712 may be present in the computer 700, connecting the computer to other types of networks and remote computer systems. In some examples, the NIC 712 may be configured to perform at least some of the techniques described herein, such as packet redirects and/or other techniques described herein.

The computer 700 may be connected to a storage device 718 that provides non-volatile storage for the computer. The storage device 718 may store an operating system 720, programs 722 (e.g., any computer-readable and/or computer-executable code described herein), and data, which have been described in greater detail herein. The storage device 718 may be connected to the computer 700 through a storage controller 714 connected to the chipset 706. The storage device 718 may consist of one or more physical storage units. The storage controller 714 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computer 700 may store data on the storage device 718 by transforming the physical state of the physical storage units to reflect the information being stored. The specific transformation of physical state may depend on various factors, in different examples of this description. Examples of such factors may include, but are not limited to, the technology used to implement the physical storage units, whether the storage device 718 is characterized as primary or secondary storage, and the like.

For example, the computer 700 may store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 may further read information from the storage device 718 by detecting the physical states or characteristics of one or more particular locations within the physical storage units.

In addition to the storage device 718 described above, the computer 700 may have access to other computer-readable storage media to store and retrieve information, such as program modules, data structures, or other data. It may be appreciated by those skilled in the art that computer-readable storage media is any available media that provides for the non-transitory storage of data and that may be accessed by the computer 700. In some examples, the operations performed by the client device 102, the mobile device 104, the network 114, the third party system(s) 116, the user statistics database 118, the application server(s) 120, the web server(s) 124, and or any components included therein, may be supported by one or more devices similar to computer 700. Stated otherwise, some or all of the operations performed by the client device 102, the mobile device 104, the network 114, the third party system(s) 116, the user statistics database 118, the application server(s) 120, the web server(s) 124, and or any components included therein, may be performed by one or more computer devices operating in a cloud-based arrangement.

By way of example, and not limitation, computer-readable storage media may include volatile and non-volatile, removable and non-removable media implemented in any method or technology. Computer-readable storage media includes, but is not limited to, RAM, ROM, erasable programmable ROM (EPROM), electrically-erasable programmable ROM (EEPROM), flash memory or other solid-state memory technology, compact disc ROM (CD-ROM), digital versatile disk (DVD), high definition DVD (HD-DVD), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 718 may store an operating system 720 utilized to control the operation of the computer 700. According to one example, the operating system 720 comprises the LINUX operating system. According to another example, the operating system comprises the WINDOWS® SERVER operating system from MICROSOFT Corporation of Redmond, Wash. According to further examples, the operating system may comprise the UNIX operating system or one of its variants. It may be appreciated that other operating systems may also be utilized. The storage device 718 may store other system or application programs and data utilized by the computer 700.

In one example, the storage device 718 or other computer-readable storage media is encoded with computer-executable instructions which, when loaded into the computer 700, transform the computer from a general-purpose computing system into a special-purpose computer capable of implementing the examples described herein. These computer-executable instructions transform the computer 700 by specifying how the CPUs 704 transition between states, as described above. According to one example, the computer 700 has access to computer-readable storage media storing computer-executable instructions which, when executed by the computer 700, perform the various processes described above with regard to FIGS. 1 through 6. The computer 700 may also include computer-readable storage media having instructions stored thereupon for performing any of the other computer-implemented operations described herein.

The computer 700 may also include one or more input/output controllers 716 for receiving and processing input from a number of input devices, such as a keyboard, a mouse, a touchpad, a touch screen, an electronic stylus, or other type of input device. Similarly, an input/output controller 716 may provide output to a display, such as a computer monitor, a flat-panel display, a digital projector, a printer, or other type of output device. It will be appreciated that the computer 700 might not include all of the components shown in FIG. 7, may include other components that are not explicitly shown in FIG. 7, or might utilize an architecture completely different than that shown in FIG. 7.

As described herein, the computer 700 may comprise one or more of the client device 102, the mobile device 104, the network 114, the third party system(s) 116, the user statistics database 118, the application server(s) 120, the web server(s) 124, and/or other systems or devices associated with the prepaid card redemption system 100 and/or remote from the prepaid card redemption system 100. The computer 700 may include one or more hardware processor(s) such as the CPUs 704 configured to execute one or more stored instructions. The CPUs 704 may comprise one or more cores. Further, the computer 700 may include one or more network interfaces configured to provide communications between the computer 700 and other devices, such as the communications described herein as being performed by the client device 102, the mobile device 104, the network 114, the third party system(s) 116, the user statistics database 118, the application server(s) 120, the web server(s) 124, and other devices described herein. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 722 may comprise any type of programs or processes to perform the techniques described in this disclosure for the client device 102, the mobile device 104, the network 114, the third party system(s) 116, the user statistics database 118, the application server(s) 120, and the web server(s) 124 as described herein. The programs 722 may enable the devices described herein to perform various operations.

### CONCLUSION

With the above-described systems and methods, a consumer may be able to conveniently access their prepaid cards to apply to purchases via an e-commerce site. Further, the user may be reminded of the existence of the prepaid cards that may be applied to a purchase via alters provided to the user during execution of the present systems and methods.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure, and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A method of value redemption, comprising:
identifying, via an application server communicatively coupled to a web server, navigation to a merchant cart webpage executed by the web server;
based at least in part on a determination that a prepaid card exists within a database communicatively coupled to the application server:
verifying information associated with the prepaid card; and
presenting an alert at a client device indicating the existence of the prepaid card; and
applying a value of the prepaid card to a purchase made via the merchant cart webpage.

2. The method of claim 1, wherein the determination that the prepaid card exists within the database communicatively coupled to the application server comprises:
accessing, via the application server, the database;
searching for the information associated with the prepaid card;
based at least in part on a determination that the information associated with the prepaid card exists in the database:
sending an acknowledgement message to the application server;
executing a browser extension at the client device;
based at least in part on a determination that the information associated with the prepaid card does not exist in the database:
sending a negative acknowledgement message to the application server indicating that information associated with the prepaid card does not exist; and
not executing the browser extension at the client device.

3. The method of claim 1, wherein the information associated with the prepaid card includes at least one of a card number, an expiry date, a card security code, a pin, a cardholder name, an issuing party, a merchant associated with the merchant cart webpage, a value of prepaid card, a quick response (QR) code, a universal resource locator (URL) of the merchant cart webpage, a URL associated with the merchant, an identification of a payment network, or combinations thereof.

4. The method of claim 1, wherein presenting the alert at the client device indicating the existence of the prepaid card comprises:
executing a browser extension on the merchant cart webpage at the client device; and
presenting the alert via the browser extension.

5. The method of claim 4, wherein applying the value of the prepaid card to the purchase made via the merchant cart webpage comprises:
via the browser extension:
identifying selection of the prepaid card for redemption towards the purchase via the merchant cart webpage;
identifying selection of a user-selectable button indicating application of the prepaid card;
inputting the information associated with the prepaid card into respective fields within the merchant cart webpage; and
completing the purchase made via the merchant cart webpage.

6. The method of claim 1, further comprising:
identifying a user-selection defining instructions to add the prepaid card to the database;
capturing the information associated with the prepaid card;
encrypting the information associated with the prepaid card to create encrypted information associated with the prepaid card; and
adding the encrypted information associated with the prepaid card to the database.

7. The method of claim 6, further comprising:
identifying execution of an application associated with the application server; and
authenticating the user with respect to the application.

8. The method of claim 7, wherein capturing the information associated with the prepaid card comprises:
imaging, via an image capture device associated with a computing device executing the application, the prepaid card based at least in part on the user-selection defining instructions to add the prepaid card to the database;
recognizing characters within an image of the prepaid card via optical character recognition; and
confirming the information associated with the prepaid card is correct.

9. The method of claim 7, wherein capturing the information associated with the prepaid card comprises identifying manual entry of the information associated with the prepaid card.

10. A non-transitory computer-readable medium storing instructions that, when executed, causes a processor to perform operations, comprising:
identifying, via an application server communicatively coupled to a web server, navigation to a merchant cart webpage executed by the web server;
based at least in part on a determination that a prepaid card exists within a database communicatively coupled to the application server:
verifying information associated with the prepaid card; and
presenting an alert at a client device indicating the existence of the prepaid card; and
applying a value of the prepaid card to a purchase made via the merchant cart webpage.

11. The computer-readable medium of claim 10, wherein the determination that the prepaid card exists within the database communicatively coupled to the application server comprises:
accessing, via the application server, the database;
searching for the information associated with the prepaid card;
based at least in part on a determination that the information associated with the prepaid card exists in the database:
sending an acknowledgement message to the application server;
executing a browser extension at the client device;
based at least in part on a determination that the information associated with the prepaid card does not exist in the database:
sending a negative acknowledgement message to the application server indicating that information associated with the prepaid card does not exist; and
not executing the browser extension at the client device.

12. The computer-readable medium of claim 11, wherein:
presenting the alert at the client device indicating the existence of the prepaid card comprises:
executing the browser extension on the merchant cart webpage at the client device; and
presenting the alert via the browser extension; and
wherein applying the value of the prepaid card to the purchase made via the merchant cart webpage comprises:
via the browser extension:
identifying selection of the prepaid card for redemption towards the purchase via the merchant cart webpage;
identifying selection of a user-selectable button indicating application of the prepaid card;
inputting the information associated with the prepaid card into respective fields within the merchant cart webpage; and
completing the purchase made via the merchant cart webpage.

13. The computer-readable medium of claim 11, wherein the information associated with the prepaid card includes at least one of a card number, an expiry date, a card security code, a pin, a cardholder name, an issuing party, a merchant associated with the merchant cart webpage, a value of prepaid card, a quick response (QR) code, a universal resource locator (URL) of the merchant cart webpage, a URL associated with the merchant, an identification of a payment network, or combinations thereof.

14. The computer-readable medium of claim 11, the operations further comprising:
identifying a user-selection defining instructions to add the prepaid card to the database;
capturing the information associated with the prepaid card;
encrypting the information associated with the prepaid card to create encrypted information associated with the prepaid card; and
adding the encrypted information associated with the prepaid card to the database.

15. The computer-readable medium of claim 14, the operations further comprising:
identifying execution of an application associated with the application server; and
authenticating the user with respect to the application,
wherein:
capturing the information associated with the prepaid card comprises:
imaging, via an image capture device associated with a computing device executing the application, the prepaid card based at least in part on the user-selection defining instructions to add the prepaid card to the database;
recognizing characters within an image of the prepaid card via optical character recognition; and
confirming the information associated with the prepaid card is correct; and
capturing the information associated with the prepaid card comprises identifying manual entry of the information associated with the prepaid card.

16. A client device comprising:
an imaging device;
a processor;
a non-transitory computer-readable media storing instructions that, when executed by the processor, causes the processor to perform operations comprising:
identifying a user-selection defining instructions to add a prepaid card to a database;
capturing information associated with the prepaid card;
encrypting the information associated with the prepaid card to create encrypted information associated with the prepaid card; and
adding the encrypted information associated with the prepaid card to the database.

17. The client device of claim 16, the operations further comprising:
identifying execution of an application associated with an application server; and
authenticating a user with respect to the application.

18. The client device of claim 17, wherein capturing the information associated with the prepaid card comprises:
imaging, via an image capture device associated with a computing device executing the application, the prepaid card based at least in part on the user-selection defining instructions to add the prepaid card to the database;
recognizing characters within an image of the prepaid card via optical character recognition; and
confirming the information associated with the prepaid card is correct.

19. The client device of claim 17, wherein capturing the information associated with the prepaid card comprises identifying manual entry of the information associated with the prepaid card.

20. The client device of claim 16, the operations further comprising:
identifying, via an application server communicatively coupled to a web server, navigation to a merchant cart webpage executed by the web server;
based at least in part on a determination that a prepaid card exists within the database communicatively coupled to the application server:
verifying information associated with the prepaid card; and
presenting an alert at a client device indicating the existence of the prepaid card; and
applying a value of the prepaid card to a purchase made via the merchant cart webpage.
